(19) United States
(12) Patent Application Publication
(10) Pub. No.: US 2019/0360555 A1
(43) Pub. Date: Nov. 28, 2019

(54) DIVIDER BAR FOR ENERGY GUIDE CHAINS

(71) Applicant: igus GmbH, Koeln (DE)

(72) Inventors: Andreas HERMEY, Hennef (DE); Stefan STRACK, Koenigswinter (DE); Thilo-Alexander JAEKER, Sankt Augustin (DE)

(21) Appl. No.: 16/478,257

(22) PCT Filed: Jan. 16, 2018
(86) PCT No.: PCT/EP2018/051008

§ 371 Date: Jul. 16, 2019

(30) Foreign Application Priority Data
Jan. 16, 2017 (DE) 20 2017 100 200.4

(51) Int. Cl. F16G 13/16; H02G 11/00

(52) U.S. Cl. CPC F16G 13/16; H02G 11/006

(57) ABSTRACT

A divider bar for an energy guide chain comprising chain links having two side plates which at least in some chain links are connected together by two transverse bars. In its central part the divider bar has at least one elongate opening in the form of a through hole for a transverse plate, wherein the opening opens to a narrow side of the divider bar by way of an insertion aperture so that a transverse plate can be inserted through the insertion aperture In relation to each opening the divider bar has a respective bending region by means of the bending of which the gap size of the insertion aperture of the associated opening can be varied. In that way the gap size of the insertion aperture, in particular in the installed state of the divider bar, can be reduced to a dimension which is slight in comparison with the internal width of the opening, whereby inter alia an inserted transverse plate is secured.

### FIELD

The invention generally concerns the field of energy guide chains for protected active guidance of lines like cables, hoses and the like. Energy guide chains are typically made up of pivotably connected chain links which have two side plates. At least in some of the chain links the side plates are stably connected together by two transverse bars and define an internal receiving space or guide passage for the lines.

The invention concerns specifically a so-called divider bar for internal division of an energy guide chain. Such divider bars serve, generally together with rung-like transverse plates or compartment plates, to form a shelf-like internal division in the receiving space of the chain links. In that way the inserted lines are guided in an orderly fashion from one chain link to another and that ordered arrangement is maintained upon displacement, which also at least reduces wear due to mutual friction of the guided lines against each other. In that case the divider bars serve for vertical division and can also be used without transverse plates. The transverse plates (also referred to as compartment plates) possible serve for horizontal division.

### BACKGROUND

Various structures for divider bars are already known from the state of the art, for example European patent EP 0 343 192 B1, German patent DE 43 13 242 C2 or patent application US 2014/0096499 A1. In that case a large number of individual parts is required and production of the desired internal division is comparatively time-consuming.

A simplification in assembly is therefore desirable. In that respect here a divider bar in accordance with German Utility Model DE 91 02 121 U1 is considered as the most relevant art, for an energy guide chain comprising pivotably connected chain links which in a conventional structure have two side plates which, at least in some chain links, are connected together by two transverse bars and define a guide passage for lines. DE 91 02 121 U1 discloses a divider bar which in its central part has a plurality of elongate openings each in the form of a through hole for receiving a respective plate-like transverse member. Each of the openings opens laterally outwardly by way of its own insertion aperture to a narrow side of the divider bar so that a transverse plate can be introduced through the insertion aperture into the opening in the divider bar by hand, and this simplifies assembly. The structure in accordance with DE 91 02 121 U1 thus simplifies in particular the selective fitment of transverse plates or compartment plates to the divider bars.

It was considered that there is the disadvantage in that respect that the rungs or transverse plates are under some circumstances not adequately fixed, that is to say not secured against separation or detachment from the divider bar. Loose transverse plates could considerably impair operation and in the worst-case scenario could lead to damage to the energy guide chain. A further development is represented by the teaching of German laid-open application DE 198 10 960 Al which also permits simple and quick fitment of the divider bars with transverse plates. Here each divider bar has an additional cover for the apertures or openings which are open towards a narrow side, and that cover secures the transverse plates. The cover however increases the number of components involved and the time involved in assembly.

A similar principle is described in DE 195 47 215 A1. The openings in the installed state of the divider bar are laterally closed and formed between two parts of the divider bar which are pivotally connected to each other through a hinge.

DE 10 2006 014 598 A1 likewise describes a two-part divider bar, wherein transverse plates can be clamped between its two parts, so that in the installed state of the divider bar the openings are laterally closed.

### SUMMARY

Accordingly, an object of the present invention is to propose a divider bar which permits quick and simple assembly of the transverse plates and nonetheless ensures a more stable connection between the transverse bar and the transverse plate.

In a divider bar of the general kind that object is already achieved in that the divider bar has in association with each opening a respective particular or pronounced bending region, wherein bending of the bending region makes it possible to selectively alter the gap size of the insertion aperture in relation to the associated or corresponding opening. In addition, it is provided according to the invention that the gap size of each insertion aperture can be reduced to a small amount in the regular installation position, and preferably is or can be minimized to a vanishingly small amount. In that respect the aim is in particular to achieve a dimension of the gap size that is markedly reduced in comparison with the internal width of the opening. A minimum gap size can thus be ensured at any event in the properly installed state of the divider bar, that is to say when it is correctly installed in a finished closed chain link. In the present case the term gap size of the insertion aperture is used to mean the free or open dimension of the insertion aperture in regard to height or main plane of the divider bar, for example the free aperture width through which the transverse plate can be introduced when the gap size is expanded to a sufficient degree or for example a gap size which is markedly smaller and minimized in relation thereto, through which the transverse plate cannot be removed without considerable force.

The reduction of the gap size of the insertion aperture in comparison with the teaching of DE 91 02 121 U1 provides in a surprisingly simple fashion for more reliable and more stable fixing of the transverse plates to the divider bar. The transverse plates cannot be detached through the insertion aperture unintentionally, for example by friction with a line. Accordingly, each insertion aperture in the closed installation position is closed to an amount sufficient for better holding the transverse plates or preferably substantially completely. By virtue of the predetermined pronounced bending regions in the transverse plate no additional fitment part is required to provide a securing action, in comparison with the teaching of DE 198 10 960 A1 .

In that respect, with a given force for spreading or clamping purposes, bending regions which are elastically bendable in the proper fashion are the regions in the main body of the divider bar, which are most greatly or most easily deformable in the main plane. Thus, in particular when the transverse bar is fitted in the chain link between two closed transverse bars or opening bars, a markedly reduced dimension of the gap size can be achieved in comparison with the internal width of the opening when the divider bar is non-loaded.

In a particularly preferred embodiment it is provided that the divider bar in the load-free or loose state is practically prestressed or of a slightly spread configuration so that the insertion apertures are at least slightly opened or expanded when the divider bar is free of external forces (loose state). That is preferably achieved by the divider bar in the loose state being of an arcuately curved configuration along its longitudinal direction in comparison with the installation position, for example by its being appropriately produced with a slightly spread-open basic shape in an injection moulding process. In that case the expanded insertion apertures, in relation to the installation position, involve a larger gap size which allows relatively simple insertion of a transverse plate or compartment plate by hand, that is to say with slight or without further bending of the divider bar. Accordingly, the gap size of the insertion apertures, in particular all insertion apertures, is perceptibly reduced when the divider bar is clamped into the chain link or compressed in the longitudinal direction from its rest position, in particular against its prestressed curvature. In that case insertion is effected for example by a transverse bar in the form of a releasable transverse bar or a transverse bar in the form of a pivotable opening bar being closed or fixed to the chain link. In this embodiment therefore the insertion apertures automatically open up when the chain link is opened by one of the two oppositely disposed transverse bars being removed. In that case the divider bar, similarly to a spring, practically “jumps open” or “jumps back” into its spread loose state. That makes the receiving means more easily accessible when the transverse bar is open and thus simplifies and accelerates assembly of the transverse plates. Instead of more typically straight structures such “prestressed” divider bars can be readily manufactured by suitable precurved shaping in the form of injection-moulded plastic components.

Transverse bars and opening bars are functionally equivalent for the present invention, therefore the term transverse bar is used here as equivalent for both.

In particular in the above-mentioned embodiment the bending region of each opening can be provided substantially in opposite relationship to the insertion aperture, for example at the other narrow side.

Preferably there are provided a plurality of openings for receiving a respective plate-like transverse plate member and each opening has its own insertion aperture through which a transverse plate can be fitted.

In an embodiment which is particularly suitable for production in the form of an injection-moulded plastic component each bending region of the divider bar is in the form of a narrowing formed by cutting away material, transversely relative to the longitudinal direction, in particular at the other narrow side of the divider bar, that is to say the narrow side which is remote from the insertion apertures.

In a preferred embodiment each insertion aperture has two mutually opposite boundary surfaces which are of an interengaging configuration, for example two conjugate or complementary surfaces. It is possible in that way in the closed state to achieve improved securing of the transverse plates and at the same time better torsional stiffness of the divider bar against rotation about its longitudinal or main axis. Preferably in that case each boundary surface has at least one recess and/or projection which cooperate with a conjugate projection and/or recess at the opposite boundary surface. In a development each boundary surface can respectively have two displaced engagement regions along the main sides of the divider bar, wherein each of those engagement regions respectively includes at least one recess and/or projection, in particular one recess and one projection. A complementary configuration in respect of the mutually opposite engagement regions means that it is possible in that way to achieve a particular torsion-resistant engagement. Other interengaging shapes of the boundary surfaces, for example rows of teeth or knob-like positive connections, are also in accordance with the invention.

In a further embodiment the bending regions can be arranged as elastically bendable portions of a continuous brace or strut at the other narrow side, that is to say at the narrow side opposite to the insertion apertures, of the divider bar, and can be provided by a material recess which expands towards the brace and in particular expands steadily, with the desired elastic bendability.

Basically, the divider bar is preferably produced continuously from the same plastic. Bending regions however can also be produced by a second more flexurally elastic plastic in a multi-component process.

An alternative or supplemental option for the desired reduction in the gap size provides that the divider bar at the respective insertion aperture of each opening in the bar has a flexible latching nose which acts similarly to a barb. Such a latching nose upon insertion of a transverse plate can sufficiently clear the insertion aperture and then spring back in order to secure or reliably hold the inserted transverse plate. For that purpose, there is provided an undercut configuration or recess into which the latching nose deflects upon insertion of the transverse plate by virtue of elastic deformation. The use of such latching noses facilitates the installation of transverse plates, but requires a special tool for the removal thereof.

In an embodiment with pronounced latching noses it is preferably provided that each latching nose is flexibly connected to the remaining body part by way of the bending region associated with the opening. In that case the latching nose can be produced in particular in one piece with the divider bar, for example in an injection moulding process, and preferably has at the one narrow side from which the transverse plates are inserted, an inclined insertion portion. In principle an inclined removal portion is also conceivable to allow dismantling without a special tool, but it is not to prevent secure fixing, that is to say it is to be designed for markedly higher forces.

Irrespective of whether the gap size is minimized by a bendable latching nose, by prestressing or clamping of the divider bar or by a suitable combination of those two measures, it is advantageous if the insertion aperture is arranged in height-displaced relationship, that is to say displaced in the longitudinal direction of the divider bar, in comparison with the main central axis of the elongate opening which typically is of a slot-shaped or oval cross-section corresponding to the transverse plate. That allows additional latching engagement of the transverse plate in the longitudinal direction of the divider bar. That provides an additional securing action to prevent undesired detachment.

In particular in connection with the last-mentioned configuration it is advantageous if the opening in the divider bar internally is of a concave, substantially oval cross-section (in the main plane of the divider bar). In conjunction with the heightwise displacement the definition of the opening thereby forms a kind of additional latching hook beneath or above the insertion aperture. Desirably the opening in the divider bar is of a configuration very substantially corresponding to the cross-section of the transverse plates, or there is a corresponding approximately oval or elongatedly round cross-section for the transverse plates.

The solution according to the invention readily makes it possible to reduce the gap size of the insertion aperture in the closed position to less than 50% of the internal width of the opening in the divider bar. In that respect the reference to the internal width of the opening is used to mean the maximum dimension of the opening in the heightwise or longitudinal direction of the divider bar corresponding to the maximum thickness to be received of the transverse plate, and therefore corresponds to the maximum wall thickness of the corresponding transverse plate or compartment plate. Preferably the reduced gap size of the insertion aperture in the installed state or in the closed position (prior to or after insertion of the transverse plate) is less than a third of the internal width of the opening in the divider bar, which provides a particularly good securing action.

In a particularly desirable embodiment the divider bar has a central portion which is of a plate-like configuration and which merges in one piece into an upper and a lower part, which are respectively designed for fixing to one of both transverse bars of the chain link. It is particularly advantageous to provide at the lower part a holding foot for mechanical fixing, in positively locking and/or force-locking relationship, to the corresponding transverse bar. Provided at the upper part in contrast is a holding means or a holding head which holds to the opposite transverse bar and loosely embraces same, only in the direction of the longitudinal extent of the energy guide chain. That makes it possible for the loosely embraced transverse bar to be in the form of an opening bar, wherein the opening thereof is not adversely affected by the divider bar. When the divider bar is of a spread or pre-curved configuration, the opening bar presses against the holding head and in so doing stresses the divider bar against its pre-curvature, preferably into a substantially perpendicular straight position. By virtue of the fixing to the lower part even a prestressed divider bar which “springs open” remains securely held to the opened chain link, even if the actual fixing is achieved exclusively by the holding foot. A suitable configuration for the holding foot is shown in DE202015101707U1.

For securing the transverse plates or compartment plates in the transverse direction, that is to say laterally in a plane perpendicularly to the direction in which the energy guide chain extends, it is advantageous if each opening in the divider bar has an associated holding spring having a latching projection which cooperates as a latching securing means with a corresponding indentation, preferably at the underside or the top side of the transverse plate.

The holding spring can be connected at one or both sides to the body of the divider bar and in particular can be produced in one piece therewith. A configuration which is shaped thereon at one side enhances the flexibility of the holding spring. Preferably in that case the holding spring has a free end which is towards the insertion aperture.

For internal division of the energy guide chain, that is as variable as possible, it is advantageous if the divider bar has at least three or more openings in its central part.

The solution according to the invention is particularly advantageous if all insertion apertures open towards one and the same narrow side of the divider bar. A systematic arrangement of all insertion apertures always in the same direction additionally simplifies assembly and subsequent changes to the internal division.

The invention further concerns a chain link for an energy guide chain having at least two divider bars which are gripped perpendicularly between both transverse bars, in accordance with an embodiment as described above, and with at least one horizontal transverse plate held by the divider bars. The invention further concerns an energy chain having a plurality of such chain links.

Finally, the invention also concerns the use of the divider bars according to the invention for initial equipment, retro-fitting or for altering the internal division in an energy guide chain.

### BRIEF DESCRIPTION OF THE DRAWINGS

Further details, features and advantages of the invention will be apparent from the more detailed description hereinafter of preferred embodiments with reference to the accompanying Figures. In the Figures which are purely by way of example and true to scale:

FIG. 1 shows a cross-section of a chain link of an energy guide chain equipped with lines and an internal division;

FIGS. 2A-2D show a first embodiment of a divider bar as a side view (FIG. 2A) of the installed state, a perspective view (FIG. 2B) of the installed state, a side view (FIG. 2C) of the loose state, and a perspective view (FIG. 2D) of the loose state, wherein FIGS. 2C-2D show the installation of transverse plates;

FIGS. 3A-3B show a second embodiment of a divider bar as a side view (FIG. 3A) and a perspective view (FIG. 3B) respectively showing the loose state of the divider bar;

FIGS. 4A-4B show a third embodiment of a divider bar as a side view (FIG. 4A) and a perspective view (FIG. 4B) respectively showing the loose state of the divider bar; and

FIGS. 5A-5D show a fourth embodiment of a divider bar as two side views (FIGS. 5C-5D) and as enlarged views of the insertion apertures from both sides (FIGS. 5A-5B).

### DETAILED DESCRIPTION

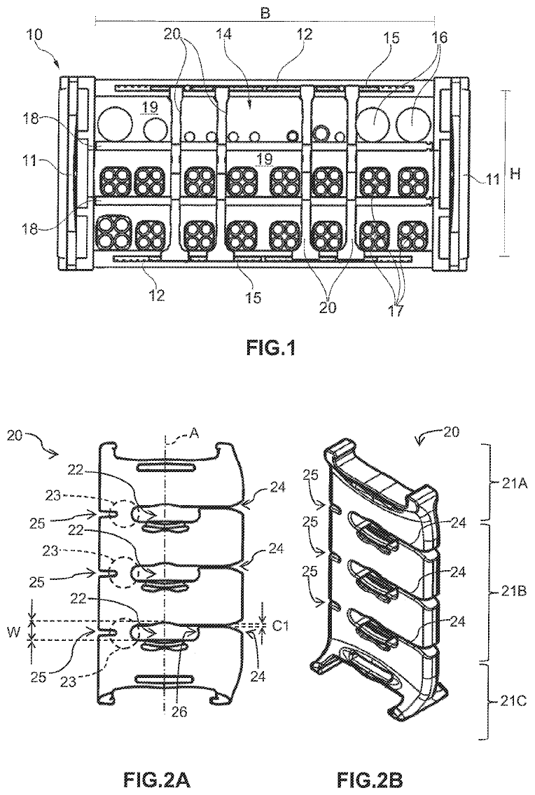

FIG. 1 shows a view in cross-section perpendicularly to the direction in which an energy guide chain 10 extends through a chain link illustrating the internal structure of the energy guide chain 10 for the active guidance of lines like for example cables 17 and hoses 16. The energy guide chain 10 is composed of a large number of pivotably interconnected chain links in a direction perpendicularly to the plane in FIG. 1. Here the chain links also comprise individual parts and have at least two outer side portions, referred to as side plates 11. In each chain link or for example each second chain link the side plates 11 are connected by two parallel identical transverse bars 12 to form a stable structure and are held at a spacing in parallel relationship. For that purpose, the transverse bars 12 are releasably fixed to horns (not shown) on the side plates 11. The side plates 11 and transverse bars 12 define a receiving space 14 for the lines 16, 17. The structure of an energy guide chain is known and can be any desired structure, for example with cranked side plates or alternate internal and external plates as the side plates 11. In particular two-part chain links are also considered, in which the two side plates 11 and a transverse bar 12 are made from one piece, that is to say in an integral member, and only the other transverse bar 12 is releasable (this is not shown).

For internal division it is known, as shown in FIG. 1, to provide horizontal transverse floors 18 or plates for dividing the height H of the receiving space 14 and vertical divider bars 20 for dividing the width B of the receiving space 14. In that case the divider bars can be latched at least at an end region in latching recesses 15 along the narrow sides of the transverse bars 12 at selectable positions in the direction of the width B and are at any event secured in the direction in which the energy guide chain 10 extends. The transverse plates 18 are to be fitted in selectable stages in respect of the height H in one of a plurality of openings which are provided in accordance with a predetermined pattern on the divider bars 12 in the form of horizontally continuous through holes. In that respect FIG. 1 shows transverse plates 18 in the form of insertion plates which are almost completely continuous over the width B, also shorter compartment plates which divide only a part of the width B are possible. The divider bars 20 extend with their main plane or longitudinal direction parallel to the side plates 11 and the transverse plates 18 parallel to the transverse bars 12. Each chain link which has transverse bars 12 is correspondingly provided with a similar internal division of the receiving space 14 for the lines 16, 17. The divider bars 20 and the transverse plates 18 are therefore to be provided at a regular spacing and in an identical arrangement at each n-th chain link in order to divide the receiving space 14 into compartments or boxes 19 which remain the same for orderly guidance of the lines 16, 17 in better protected relationship.

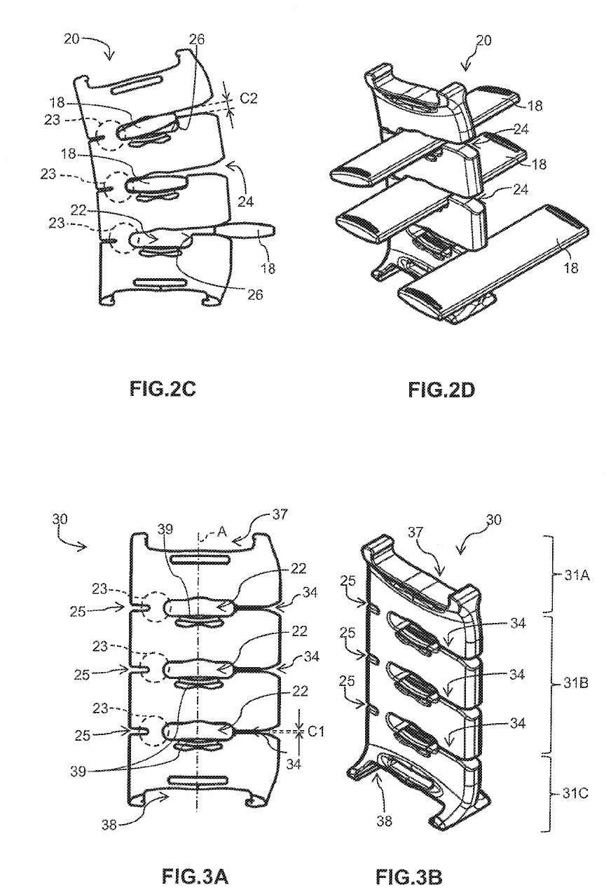

FIGS. 2A-2D show a divider bar 20 of a first embodiment. Along its longitudinal direction A the divider bar 20 has an upper part 21A, a plate-like central part 21B and a lower part 21C. Provided in the central part 21B here are a plurality of, for example three, identical openings 22. A plate-like compartment or transverse plate 18 can be inserted by way of an insertion aperture 24 into each opening 22 selectively depending on the respectively desired internal division (see FIG. 1). Each opening 22 extends in the form of a through hole through the central part 21B and is of an elongately oval cross-section with its transverse axis transversely relative to the longitudinal direction A in matching relationship with the transverse plates 18. For fitting a transverse plate 18 each opening 22 has a respectively specific insertion aperture 24 opening laterally outwardly at a narrow side of the divider bar 20. Thus, each opening 22 is accessible from that narrow side, that is to say the transverse plate 18 can be inserted into the opening 22 through the insertion aperture 24.

FIGS. 2A-2B show the normal installation state of the divider bar 20 as in FIG. 1, in which the gap size C1 of the insertion aperture 24 is minimized to a negligibly slight amount, for example substantially to zero, by the defining surfaces above and below the insertion aperture 24 bearing closely against each other or being in butting relationship. The gap size C1 of the insertion aperture 24 is therefore considerably smaller in comparison with the internal width W of the opening 24, at any event C1<<W/3, so that a transverse plate 18 cannot be released of its own accord from the opening 22 through the insertion aperture 24 even in the event of an unusual force acting thereon from the exterior, for example due to friction of the lines 16, 17. That is made possible by the divider bar 20 having a respective bending region 23 in association with each opening 22 in the central region 21B. When the bending region 23 is bent open the gap size C1 of the insertion aperture 24 of the associated opening 22 is increased. In that case the bending region 23 of each opening 22 is provided in the region of the main axis of the opening 22 at the other narrow side opposite to the insertion apertures 24 at the one side. For sufficient bendability with a relatively stiff plastic material from which the divider bar 20 is made in one piece using injection moulding, each bending region 23 can be in the form of a narrowing or a weakening of material, in particular by the provision of a notch 25 or a material recess which is provided transversely relative to the longitudinal direction A in the narrow side, for example in alignment with the main axis of the opening 22.

FIGS. 2C-2D show the divider bar 20 when not installed, that is to say in the non-loaded state. The loose divider bar 20 as shown in FIGS. 2C-2D is provided with expanded insertion apertures 24, that is to say with a gap size C2 which is markedly larger in comparison with the installed state in FIGS. 2A-2B or FIG. 1. The transverse plates 18 can be easily inserted by hand through the opened, expanded insertion apertures 24. Upon closure of the chain link to the state shown in FIG. 1 the gap size of each insertion aperture 24 is minimized by clamping of the divider bar 20 between the two oppositely disposed transverse bars 12 as shown in FIGS. 2A-2B. For the purposes of enlargement in the release state of the divider bar 20 it can be produced with a pre-curvature, that is to say in a basic shape which is arcuately pre-curved along the longitudinal direction A, as an injection-moulded component, being therefore virtually pre-stressed towards expansion. Rotation of the transverse plates 18 about the longitudinal axis thereof widens the insertion apertures 24. The transverse plates 18 can thus be removed when at least one transverse bar 12 is removed. Closed transverse bars 12 serve as a securing means to prevent the arrangement from being spread or bent open.

For the purposes of additional latching, in FIGS. 2A-2D each gap-like insertion aperture 24 is displaced upwardly in the longitudinal direction A or in the direction of the height H with respect to the main axis of the opening 22, so that the transverse plates 18 latch transversely relative to the displacement in the insertion direction. In that situation the convex boundary of the opening 22 forms below the insertion aperture 24 a kind of latching hook 26, as can best be seen from FIGS. 2A/2C.

When a transverse bar 12, in particular the transverse bar 12 at the upper part 21a is removed, the divider bar 20 spreads open into its unloaded rest position as shown in FIGS. 2C-2D in which the transverse plates 18 or compartment plates can be easily inserted by hand.

The embodiment of FIGS. 3A-3B is identical in many features to that shown in FIGS. 2A-2D. Thus, for example the divider bar 30 also has rounded edges at the narrow sides of the central part 31B and at the upper and lower parts 31A, 31B. At the upper part 31A it also has a holding head 37 which latches only slightly or easily releasably to the transverse bar 12, but embraces the narrow sides of the transverse bar for longitudinal securing purposes. As in FIGS. 2A-2D, the lower part 31B in FIGS. 3A-3B also has a clippable or latchable holding foot 38 with pronounced latching projections at mutually opposite claws of the holding foot 28. Those wider claws of the holding foot 38 can firmly latch into the toothed latching recess 15 of a transverse bar 12 and thus cooperate as positioning latching means. The divider bars 30 are preferably so arranged that their more easily releasable holding head 37 is always disposed radially outwardly in relation to the deflection arc movement of the energy guide chain 10 (FIG. 1).

As in FIGS. 2A-2D each opening 32 in FIGS. 3A-3B has a holding spring 39 which is in one piece in the manner of a leaf spring, with a latching projection which engages into a corresponding indentation in the transverse plate 18 (not shown). That secures the transverse plate 18 against transverse displacement, that is to say perpendicularly to the plane of FIGS. 2A/3A. Securing of the holding spring 39 is advantageous in particular in relation to shorter compartment plates (not shown), the length of which corresponds to only a small proportion of the width B of the chain link (FIG. 1) and which are not intended to project laterally from the divider bar 20 or 30 respectively.

The essential difference with the divider bar 30 of FIGS. 3A-3B in relation to FIGS. 2A-2D is that the divider bar 30 has insertion apertures 34 which are minimized even in its loose non-loaded state, that is to say it has no prestressing in the longitudinal direction A. Accordingly more force has to be applied upon insertion for installation of the transverse plates 18. For easier spreading of the gap size each insertion aperture 34 is provided with inclined insertion portions expanding towards the narrow side, at its mouth. By virtue of the oppositely disposed bending regions 23 the insertion aperture 34 which is in the form of an insertion gap can be only enlarged when a transverse plate 18 is inserted or is rotated for removal. In FIGS. 3A-3B the insertion apertures 34 are preferably disposed centrally in relation to the height of the corresponding opening 22, that is to say they are not displaced in respect of height. Closed transverse bars 12 serve as securing means.

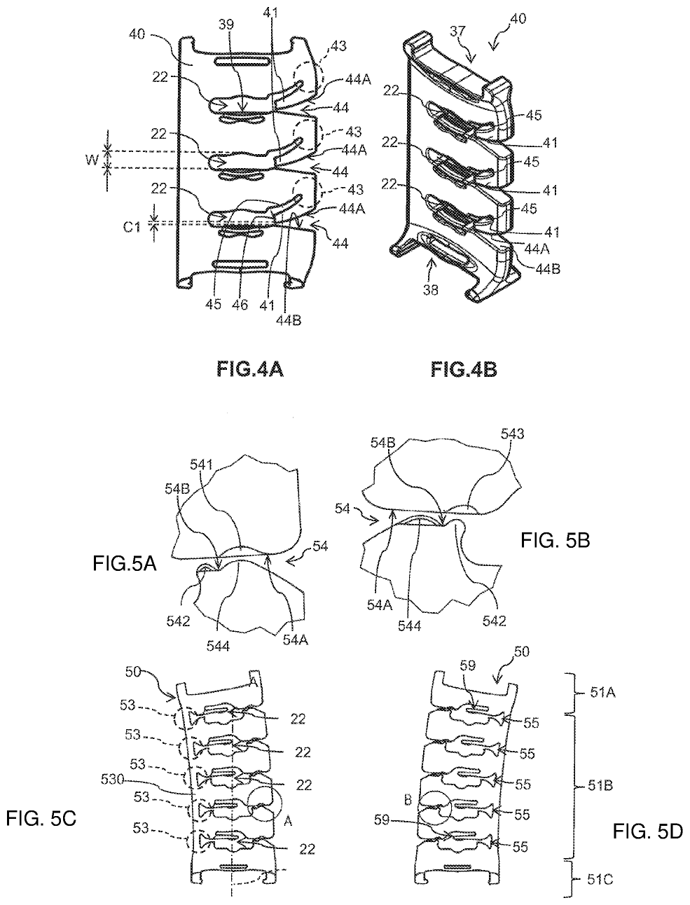

FIGS. 4A-4B show an alternative embodiment. The divider bar 40 differs in its structure in particular in the way in which, by means of bending, the gap size of the insertion aperture 44 of each opening 22 in the divider bar is reduced to a size which is small in comparison with the internal width of the opening or the maximum thickness of the transverse plate 18. At each insertion aperture 44, that is to say towards each opening 22, the divider bar 40 shown in FIGS. 4A-4B has a bendable tongue for latching engagement, that is to say a latching nose 41, which upon insertion of a transverse plate 18 opens the insertion aperture 44 and, similarly to a barb, holds or secures the inserted transverse plate 18. Each latching nose 41 is produced flexibly and in one piece with the divider bar 40 by way of an associated bending region 43. In FIGS. 4A-4B the bending regions 43 are provided above the openings 22 so that the latching noses 41 extend from the outside inclinedly downwardly to the opening 22. An undercut configuration or recess 45 extending between the bending region 43 and the opening 22 allows the wedge-shaped latching nose 41 to deflect. The free end 46 of the latching nose 41 is concavely cut inwardly in the cross-section of the member in matching relationship with the cross-section of the transverse plates 18 or compartment plates. For easier insertion of a transverse plate 18 each latching nose 41 preferably has an inclined insertion portion 44A which enlarges outwardly towards the narrow side, as the configuration defining the insertion aperture 44. A further inclined insertion portion 44B of the divider bar 40 is opposite the inclined insertion portion 44A.

In spite of facilitated installation the embodiment of FIGS. 4A-4B allows the gap size C1 of the insertion aperture 44 to be minimized to a dimension which is very slight in comparison with the internal width of the opening 22 without a weakening of material by virtue of notching at the remote narrow side. For later removal of a fitted transverse plate 18 however a tool is required in order to unlock the latching nose 41 or make the insertion aperture 44 accessible.

Features of embodiments can be combined together, for example to avoid a special tool, a latching nose 41 which closes less strongly as shown in FIGS. 4A-4B with an in part prestressed structure as shown in FIGS. 2A-2D. Parts involving a similar or identical structure or mode of operation are denoted by corresponding references and are not described again here.

FIGS. 5A-5D show a further preferred embodiment of a divider bar 50. The upper and lower parts 51A and 51C respectively can be of the design as described above. Only the essential differences which lie in the configuration of the central part 51B of the divider bar 50 are described here.

FIGS. 5C-5D show the divider bar 50 in the non-loaded state, with a curvature which is predetermined by virtue of the manner of manufacture thereof, or involving a slightly stretched basic shape. In the divider bar 50 the bending regions 53 are respectively in the form of bendable portions of a continuous strut or brace 530 at the narrow side of the divider bar 50, which is in opposite relationship to the insertion apertures 54. Good elastic bendability of the bending regions 53 is formed by a respectively associated material recess 55 which is steadily widened towards the brace 530, for example similarly to a cup or trumpet form (FIG. 5D), which here passes through the entire body of the divider bar 55. The holding spring 59 for latching with the transverse plate 18 (not shown in FIG. 5) is here respectively shaped at the top at the openings 22 and at one side, with a freely projecting end towards the insertion aperture 54.

As FIGS. 5A-5B best show the divider bar 50 is of an advantageous configuration in respect of the mutually opposite upper and lower boundary surfaces 54A, 54B which define the insertion aperture 54 upwardly and downwardly. Adjoining the inclined insertion portions, similarly to FIG. 4, two respective recesses 541, 543 are provided towards the opening 22 in the upper boundary surface 54A. The recesses 541, 543 engage into matchingly shaped, complementary projections 542, 544 of the lower boundary surface 54B, in particular in the closed state. As can be seen from the two side views in FIGS. 5A-5B each boundary surface 54A, 54B in this case preferably forms two engagement regions which are arranged in displaced relationship respectively, as recesses 541, 543 or the projections 542, 544 are displaced in the insertion direction and respectively extend in respect of depth only approximately over a maximum of half the wall thickness of the divider bar 50 in that region. That provides a better closing action in respect of the insertion apertures 54 and in addition improves the torsional stiffness of the divider bar 50 overall about the longitudinal axis A, possibly also already by lateral overlap in the non-loaded state.

### List of References

### FIG. 1

10 energy guide chain

11 side plate

12 transverse bar

14 receiving space

15 latching recess

16 hose

17 cable

18 transverse plate or compartment plate

19 compartment

20 divider bar

H height

B width

### FIGS. 2A-2D

20 divider bar

22 opening

23 bending region

24 insertion aperture

25 notch

26 latching hook

37 holding head

38 holding foot

39 holding spring

A longitudinal axis

C1 gap size (closed)

C2 gap size (open)

W internal width

### FIGS. 3A-3B

30 divider bar

22 opening

23 bending region

34 insertion aperture

25 notch

37 holding head

38 holding foot

39 holding spring

### FIGS. 4A-4B

40 divider bar

22 opening

41 latching nose

43 bending region

44 insertion aperture

44A, 44B inclined insertion portion

45 recess

46 free end

37 holding head

38 holding foot

39 holding spring

C1 gap size (closed)

W internal width

### FIGS. 5A-5D

22 opening

50 divider bar

53 bending region

530 brace

54 insertion aperture

55 material recess

54A, 54B boundary surfaces

541, 543 recess

542, 544 projection

59 holding spring

What is claimed is:

1-18. (canceled)

19. The divider bar for an energy guide chain comprising pivotably connected chain links having two side plates, which at least in regard to some chain links are connected together by two transverse bars, and define a guide passage for lines, wherein in its central part the divider bar has a plurality of elongate openings each in the form of a through hole for receiving a respective plate-like transverse plate member and each of the openings opens by way of its own insertion aperture to a narrow side of the divider bar so that a transverse plate can be inserted into the opening through the insertion aperture,
wherein
the divider bar has in association with each opening a respective bending region, by the bending of which the gap size of the insertion aperture of the associated opening can be altered, and
the gap size of the insertion aperture, at least in a closed position which corresponds to the installed state of the divider bar, is reduced in comparison with the internal width of the opening, namely is less than 50% of the internal width of the opening.

20. The divider bar according to claim 19, wherein in the loose state the divider bar has expanded insertion apertures, wherein each insertion aperture has a gap size which is greater than in the installed state, for the insertion of a transverse plate, and that the gap size of each insertion aperture can be reduced by clamping of the divider bar between two transverse bars against a pre-curvature of the divider bar.

21. The divider bar according to claim 19, wherein in relation to each opening the divider bar has a bending region in substantially opposite relationship to the insertion aperture.

22. The divider bar according to claim 21, wherein each bending region is formed by a narrowing at the other narrow side of the divider bar.

23. The divider bar according to claim 19, wherein each insertion aperture has two mutually opposite boundary surfaces which are of an interengaging configuration.

24. The divider bar according to claim 23, wherein each boundary surface has at least one recess and/or projection, preferably two respective engagement regions which are arranged in displaced relationship, wherein each engagement region respectively includes at least one recess and/or projection.

25. The divider bar according to claim 19, wherein the bending regions are arranged as bendable portions of a continuous brace at the other narrow side of the divider bar and are formed by a material recess which widens towards the brace.

26. The divider bar according to claim 19, wherein at the insertion aperture of each opening the divider bar has a bendable latching nose which upon insertion of a transverse plate opens the insertion aperture and holds the inserted transverse plate.

27. The divider bar according to claim 26, wherein each latching nose is bendable by way of the associated bending region and is in one piece with the divider bar and preferably has an inclined insertion portion which widens towards the other narrow side.

28. The divider bar according to claim 19, wherein the insertion aperture is arranged in height-displaced relationship in comparison with the main axis of the elongate opening for latching engagement of the transverse plate in the longitudinal direction of the divider bar.

29. The divider bar according to claim 27, wherein the opening is of a concave shape corresponding to a substantially oval cross-section of the transverse plates.

30. The divider bar according to claim 19, wherein the gap size of the insertion aperture in the closed position is less than 33% of the internal width of the opening, and is minimized.

31. The divider bar according to claim 19, wherein the central part is of a plate-like configuration and the divider bar has an upper and a lower part, wherein provided on the lower part is a holding foot for fixing to a transverse bar in positively locking and/or force-locking relationship.

32. The divider bar according to claim 19, wherein each opening has a holding spring having a latching projection which can latch into a corresponding indentation in the transverse plate for securing in the transverse direction.

33. The divider bar according to claim 19, wherein the divider bar has at least three openings in its central part and all insertion apertures open to the same narrow side of the divider bar.

34. A chain link for an energy guide chain including two side plates which are connected together by two transverse bars and define a guide passage for lines, wherein at least one transverse bar is in the form of an opening bar, comprising at least two divider bars according to claim 19, which are clamped perpendicularly between both transverse bars and at least one horizontal transverse plate which is held by the divider bars for internal division of the guide passage.

35. An energy guide chain including a plurality of chain links according to claim 34.

36. Use of divider bars according to claim 19 for original fitment or retro-fitment of an energy guide chain with an internal division.
